(19) United States
(12) Patent Application Publication
(10) Pub. No.: US 2026/0278253 A1
(43) Pub. Date: Sep. 17, 2026

(54) TEXT GENERATION PROGRAM AND INFORMATION PROCESSING APPARATUS

(71) Applicant: YOUTRUST, Inc., Tokyo (JP)

(72) Inventor: Masahiro YAMADA, Tokyo (JP)

(21) Appl. No.: 19/669,909

(22) Filed: May 6, 2026

Related U.S. Application Data
(63) Continuation of application No. PCT/JP2024/028173, filed on Aug. 7, 2024.

(30) Foreign Application Priority Data
Nov. 7, 2023 (JP) 2023-189756

(51) Int. Cl. G06F 40/166; G06Q 10/1053

(52) U.S. Cl. CPC G06F 40/166; G06Q 10/1053

(57) ABSTRACT

To provide a text generation program and an information processing apparatus that create a sentence according to a transmission destination user and a transmission purpose. An information processing apparatus includes: a user selection means that selects a transmission destination user of a scout sentence, a recruitment selection means that selects recruitment information prepared in advance, an attractive point extraction request means that requests a generative AI to extract a plurality of attractive points from user information of the selected user, and a text generation request means that requests the generative AI to understand the recruitment information prepared in advance and generate a sentence for the user on the basis of the extracted plurality of attractive points.

### CROSS-REFERENCE TO RELATED APPLICATIONS

The present application is a bypass continuation application based on and claims the benefit of priority from the prior Japanese patent application No. 2023-189756 filed on Nov. 7, 2023, and PCT Application No. PCT/JP2024/028173 filed Aug. 7, 2024, the entire contents of which are incorporated herein by reference.

### TECHNICAL FIELD

The present invention relates to a text generation program and an information processing apparatus.

### BACKGROUND ART

As a conventional technology, an information processing apparatus that reuses a previously used document when creating a standard document has been proposed (see, for example, Patent Literature 1).

The information processing apparatus disclosed in Patent Literature 1 includes a message storage means for accumulating transmitted and received messages, a selection condition input means for inputting a selection condition including the presence or absence of a reuse relationship in order to acquire a message from the message storage means, a message selection means for selecting a desired message from the message storage means using the selection condition input from the selection condition input means, a message creation means for displaying the message selected by the message selection means as a reuse source message and creating a new message, and a message reuse relationship storing means for storing a correspondence relationship between the new message created by the message creation means and the reuse source message in a message reuse relationship storage means. With this configuration, when creating a standard document, the information processing apparatus of Patent Literature 1 searches for a template document from the accumulated documents, and edits the template document to create a desired document.

### CITATION LIST

### Patent Literature

Patent Literature 1: JP 2004-302797 A

### SUMMARY OF INVENTION

### Technical Problem

According to the information processing apparatus described above, when a standard document is created, a template document is found from the accumulated documents, and the template document is edited to create a desired document. However, there is a problem that it is not possible to create a sentence according to the characteristics of a transmission destination user and the transmission purpose as in a case where, for example, the right personnel is found and then a sentence for inviting the personnel is created.

An object of the present embodiment is to provide a text generation program and an information processing apparatus that create a sentence according to a transmission destination user and the transmission purpose.

### Solution to Problem

In order to achieve the above object, one aspect of the present embodiment provides the following text generation program and information processing apparatus.
[1] A text generation program for causing a computer to function as:
a selection means configured to receive selection of a transmission destination user of a scout sentence and recruitment information prepared in advance;
an extraction request means configured to request a generative AI to extract a plurality of attractive points from user information of the user; and
a generation request means configured to request the generative AI to understand the recruitment information prepared in advance and generate a sentence for the user on the basis of the plurality of extracted attractive points.
[2] The text generation program according to [1], further causing the computer to function as
a generation means configured to generate a scout sentence using at least one of the sentence for the user generated by the generative AI and a fixed phrase prepared in advance. [3] The text generation program according to [2], in which the generation request means requests the generative AI to generate the sentence for a type other than the type of the fixed phrase prepared in advance. [4] The text generation program according to any one of [1] to [3], in which the generation request means requests the generative AI to learn past text of a transmission source user and adapt the sentence to a style of the transmission source user. [5] The text generation program according to any one of [1] to [3], in which the generation request means requests the generative AI to mention a common career of a user who is a common friend of the transmission source user and the transmission destination user when requesting the generation of the sentence. [6] The text generation program according to any one of [1] to [3], in which the generation request means requests the generative AI to learn sentence generation using a scout sentence with a high response rate. [7] An information processing apparatus including:
a selection means configured to receive selection of a transmission destination user of a scout sentence and recruitment information prepared in advance;
an extraction request means configured to request a generative AI to extract a plurality of attractive points from user information of the user; and
a generation request means configured to request the generative AI to understand the recruitment information prepared in advance and generate a sentence for the user on the basis of the plurality of extracted attractive points.
[8] A sentence generation method including:
a step of receiving selection of a transmission destination user of a scout sentence and recruitment information prepared in advance;
a step of requesting a generative AI to extract a plurality of attractive points from user information of the user; and
a step of requesting the generative AI to understand the recruitment information prepared in advance and generate a sentence for the user on the basis of the plurality of extracted attractive points. [9] An information processing system including:
a generative AI configured to generate at least a sentence in response to a request; and
an information processing apparatus including a selection means configured to receive selection of a transmission destination user of a scout sentence and recruitment information prepared in advance, an extraction request means configured to request a generative AI to extract a plurality of attractive points from user information of the user, and a generation request means configured to request the generative AI to understand the recruitment information prepared in advance and generate a sentence for the user on the basis of the plurality of extracted attractive points.

### Advantageous Effects of Invention

According to one or more embodiments, it is possible to generate a sentence based on a transmission destination user and a transmission purpose.

According to one or more embodiments, it is possible to generate a message using at least one of sentences generated for a user by a generative AI and a pre-stored fixed phrase.

According to one or more embodiments, it is possible to request the generative AI to generate a sentence of a type different from the type of the pre-stored fixed.

According to one or more embodiments, it is possible to request the generative AI to learn past messages of the transmission source user and generate a sentence reflecting a style of the transmission source user.

According to one or more embodiments, when requesting generation of the sentence, it is possible to request the generative AI to include information relating to a shared connection between the transmission source user and the transmission destination user.

According to one or more embodiments, it is possible to request a pre-trained AI to learn sentence generation using messages associated with a high response rate.

### BRIEF DESCRIPTION OF DRAWINGS

FIG. 1 is a schematic diagram illustrating an example of a configuration of an information processing system according to an embodiment.

FIG. 2 is a block diagram illustrating a configuration example of an information processing apparatus according to the embodiment.

FIG. 3 is a schematic diagram illustrating a configuration example of user information.

FIG. 4 is a schematic diagram illustrating a configuration example of recruitment information.

FIG. 5 is a schematic diagram illustrating a configuration example of fixed phrase information.

FIG. 6 is a schematic diagram illustrating a configuration example of a screen displayed on a display unit of a terminal.

FIG. 7 is a schematic diagram illustrating a configuration example of a screen displayed on a display unit of a terminal.

FIG. 8 is a schematic diagram illustrating a configuration example of a screen displayed on a display unit of a terminal.

FIG. 9 is a schematic diagram illustrating a configuration example of a screen displayed on a display unit of a terminal.

FIG. 10 is a schematic diagram illustrating a configuration example of a screen displayed on a display unit of a terminal.

FIG. 11 is a flowchart for describing a scout sentence creation operation.

### DESCRIPTION OF EMBODIMENTS

### Embodiment

### Configuration of Information Processing System

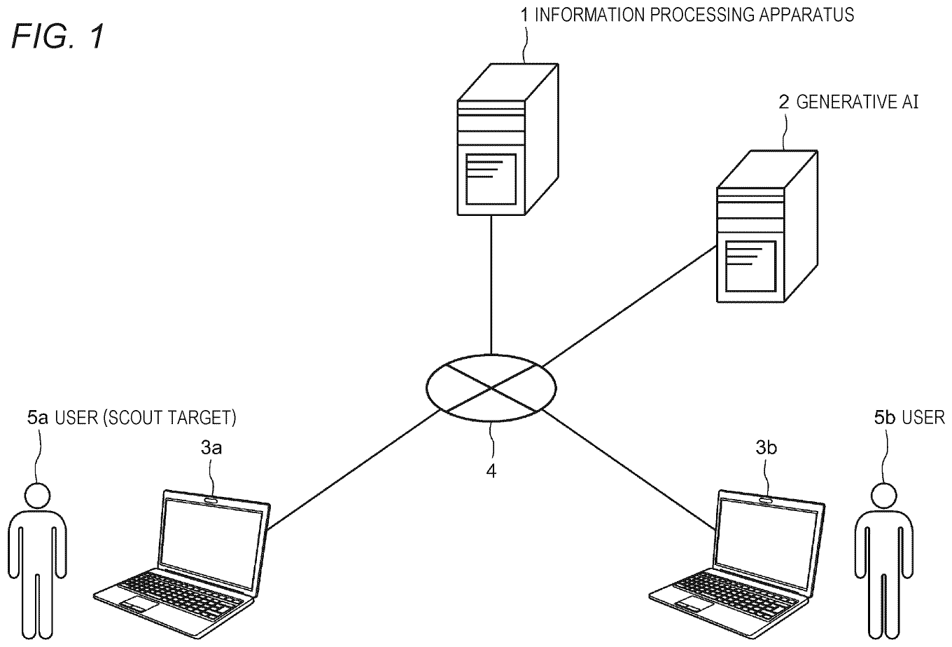

FIG. 1 is a schematic diagram illustrating an example of a configuration of an information processing system according to an embodiment.

This information processing system is configured by connecting an information processing apparatus 1, a generative AI 2, and terminals 3a, 3b, . . . such that they can communicate with each other via a network 4. The terminals 3a, 3b, . . . are operated by users 5a, 5b, . . . , respectively.

The information processing apparatus 1 is a server type information processing apparatus, operates in response to a request from the terminals 3a, 3b, . . . , and includes electronic components such as a central processing unit (CPU) and a flash memory having a function for processing information in a main body.

The generative AI 2 is a server type information processing apparatus, mainly functions as a generative AI that trains a neural network and generates text or the like for a certain input, operates in response to a request of the information processing apparatus 1, and includes electronic components such as a CPU, a graphics processing unit (GPU), and a flash memory having a function for processing information in a main body. The generative AI 2 can use a generally provided service, and may use, for example, Azure OpenAI Service, OpenAI API, or the like.

Each of the terminals 3a, 3b, . . . is an information processing apparatus such as a personal computer (PC), and includes electronic components such as a CPU and a flash memory having a function for processing information in a main body.

The network 4 is a communication network capable of high-speed communication, and is, for example, a wired or wireless communication network such as an intranet or a local area network (LAN).

As an example, the information processing apparatus 1 generates text (hereinafter sometimes referred to as “scout sentence”) to scout the user 5a in response to a request from the terminal 3b. Specifically, when the user 5a who is a scout target and certain recruitment information are selected in the terminal 3b, the information processing apparatus 1 works in conjunction with the generative AI 2 to generate text for scouting with content for the user 5a according to the content of the recruitment information.

### Configuration of Information Processing Apparatus

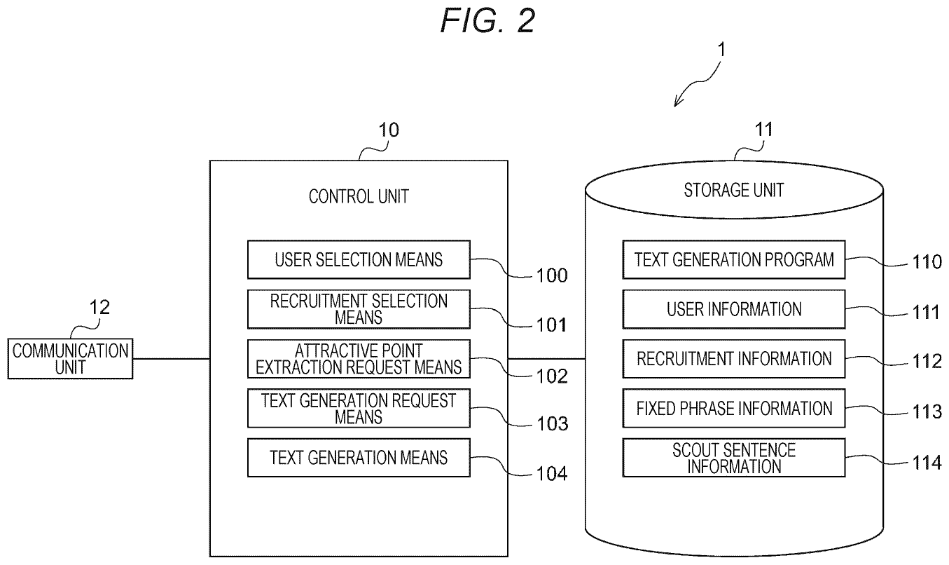

FIG. 2 is a block diagram illustrating a configuration example of the information processing apparatus 1 according to the embodiment.

The information processing apparatus 1 includes a control unit 10 that includes a CPU and the like, controls each unit, and executes various programs, a storage unit 11 that includes a storage medium such as a flash memory and stores information, and a communication unit 12 that communicates with the outside via the network 4.

The control unit 10 functions as a user selection means 100, a recruitment selection means 101, an attractive point extraction request means 102, a text generation request means 103, a text generation means 104, and the like by executing a text generation program 110 to be described later.

The user selection means 100 selects a transmission destination user of a scout sentence as a scout target from the users of user information 111.

The recruitment selection means 101 selects a job requisition for scouting from recruitment information 112.

The attractive point extraction request means 102 requests the generative AI 2 to extract, for example, three attractive points of a user on the basis of information of the user selected from the user information 111 by the user selection means 100.

The text generation request means 103 requests the generative AI 2 to understand the content of the recruitment information 112 and generate a sentence for the user on the basis of the three attractive points extracted by the attractive point extraction request means 102.

The text generation means 104 performs display processing of the generation result generated by the generative AI 2 on the terminals 3a, 3b, . . . , generates scout sentence information 114 on the basis of the operation content received for the display result, and stores the scout sentence information 114 in the storage unit 11.

The storage unit 11 stores the text generation program 110 that cause the control unit 10 to operate as the units 100 to 104 described above, the user information 111, the recruitment information 112, fixed phrase information 113, the scout sentence information 114, and the like.

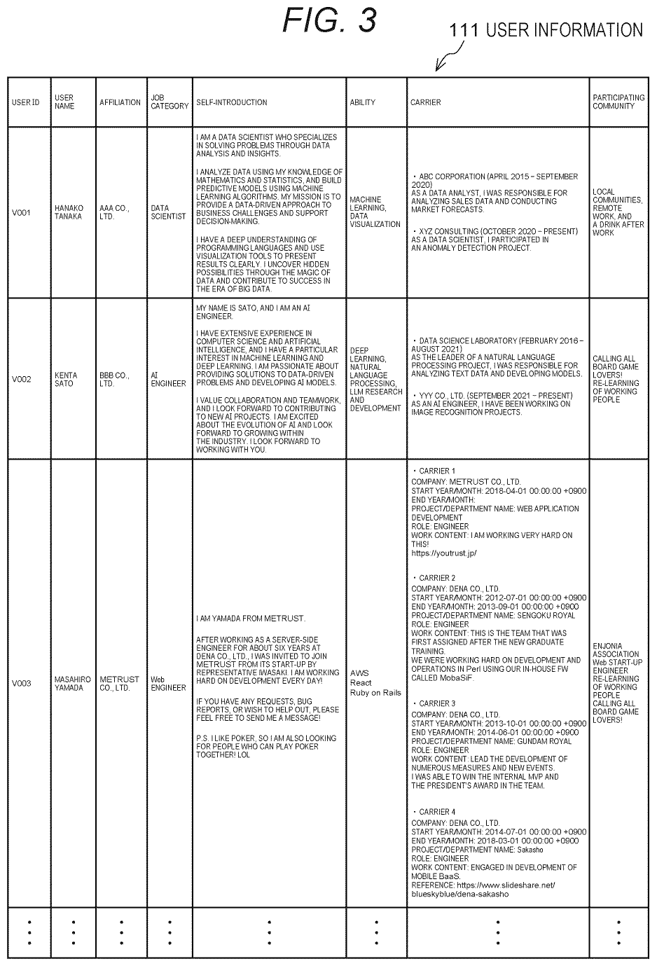

FIG. 3 is a schematic diagram illustrating a configuration example of the user information 111.

The user information 111 includes a user ID for identifying a user, a user name, affiliation indicating a company or the like to which the user belongs, a job category, a self-introduction, ability, career indicating a job history, a participating community indicating a community in which the user participates, and the like.

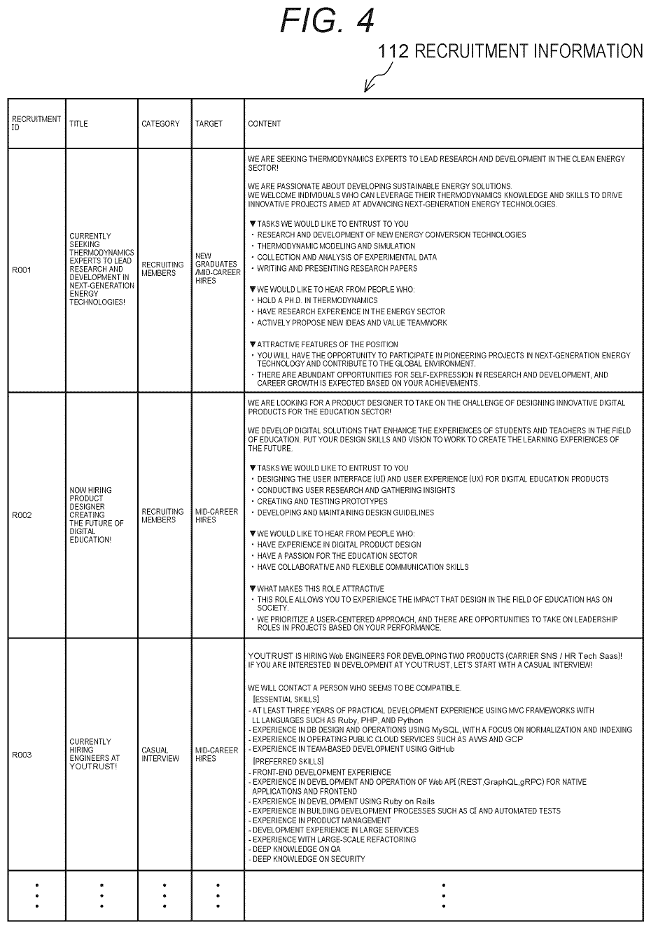

FIG. 4 is a schematic diagram illustrating a configuration example of the recruitment information 112.

The recruitment information 112 includes a recruitment ID for identifying a recruitment, a title, a category, a target, and content. The category is a category regarding the purpose of recruitment, and includes items such as formal “member recruitment” and “casual interview” that can be participated in even without an intention to change jobs.

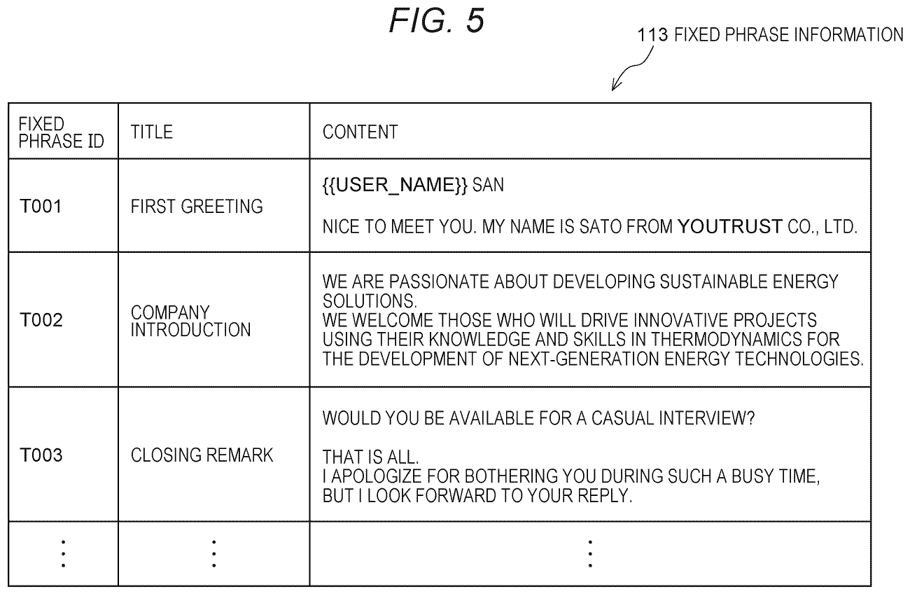

FIG. 5 is a schematic diagram illustrating a configuration example of the fixed phrase information 113.

The fixed phrase information 113 includes a fixed phrase ID for identifying a fixed phrase, a title, and content.

### Operation of Information Processing Apparatus

Next, the operation of the present embodiment will be described separately for (1) preparation operation, (2) scout sentence creation operation, and (3) fixed phrase registration and editing operation.
(1) Preparation operation

First, the user 5a who is a job seeker operates the terminal 3a to input information such as a user name, affiliation, job category, self-introduction, ability, career which is a job history, and participating community in order to register for the service provided by the information processing apparatus 1. The input information is transmitted from the terminal 3a to the information processing apparatus 1, and is recorded in the storage unit 11 as the user information 111.

In addition, the user 5b who desires to scout personnel operates the terminal 3b to register for the service provided by the information processing apparatus 1 in a similar manner, and then operates the terminal 3b to register information such as a title, a category, a target, and content as content of recruitment. The input information is transmitted from the terminal 3b to the information processing apparatus 1, and is recorded in the storage unit 11 as the user information 111 and the recruitment information 112.

In addition, the user 5b registers a fixed phrase to be used as a scout sentence to be transmitted when the user 5b operates the terminal 3b to scout personnel. The input information is transmitted from the terminal 3b to the information processing apparatus 1, and is recorded in the storage unit 11 as the fixed phrase information 113. Note that the fixed phrase information 113 to be registered here is a sentence other than the sentence generated by the generative AI 2, such as an introduction greeting, a company introduction, schedule adjustment of an interview, and closing remarks. Note that details of the operation of registering the fixed phrase will be described in “(3) Fixed phrase registration and editing operation”.
(2) Scout sentence creation operation

Next, the user 5b operates the terminal 3b to browse registered user information via the service provided by the information processing apparatus 1. Hereinafter, a situation in which the user 5b scouts the user 5a for a job category that the user 5b is recruiting for will be described.

The user 5b first operates the terminal 3b to request display of a screen for creating a scout sentence. When a request is transmitted from the terminal 3b to the information processing apparatus 1, a screen for creating a scout sentence is controlled to be displayed on the terminal 3b. While checking the display screen of the terminal 3b, the user 5b operates the terminal 3b to select a transmission destination user of the scout sentence.

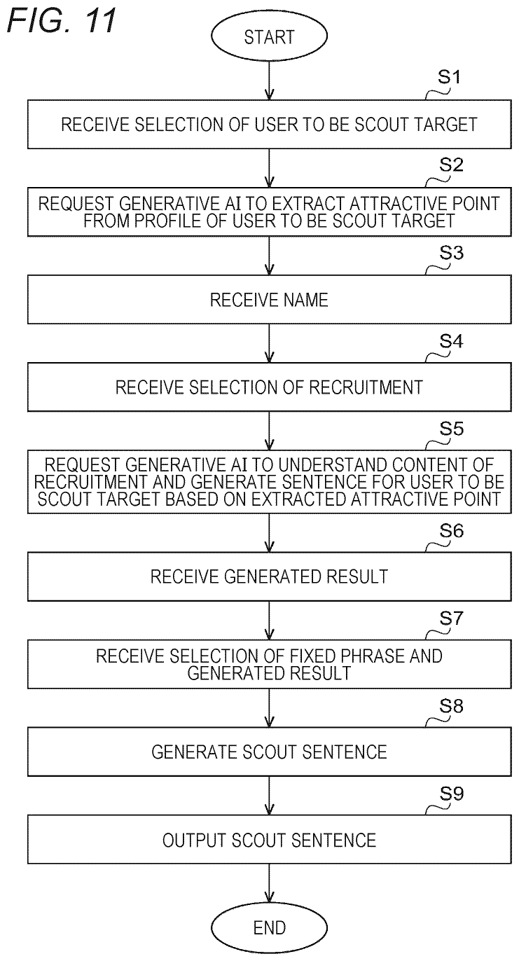

FIG. 11 is a flowchart for describing a scout sentence creation operation.

The user selection means 100 of the information processing apparatus 1 selects a transmission destination user of a scout sentence as a scout target from among the users of the user information 111 in accordance with the operation content of the terminal 3b (S1). For example, a case where “Masahiro Yamada” of the user ID “V003” of the user information 111 of FIG. 3 is selected will be described.

Next, the attractive point extraction request means 102 requests the generative AI 2 to extract, for example, three attractive points of the user on the basis of the information (profile) of the user selected by the user selection means 100 from the user information 111 (S2). Here, the profile includes affiliation, job category, self-introduction, ability, career, and participating community of the user information 111.

The attractive point extraction request means 102 requests the generative AI 2 as follows, for example. “First, read the following profile text. ========== Mr. Yamada's profile information ==========
Company to which other party belongs

### METRUST Co., Ltd.

Job category of other party
   Engineering/Web engineer
Self-introduction of other party
   I am Yamada from METRUST.
   After working as a server-side engineer for about six years at DeNA Co., Ltd., I was invited to join METTRUST from its start-up by representative Iwasaki. I am working hard on development every day!
   If you have any requests, bug reports, or wish to help out, please feel free to send me a message!
   P.S. I like poker, so I am also looking for people who can play poker together! lol
Ability of other party

### AWS

### React

### Ruby on Rails

Career of other party
Career 1

### Company: METRUST Co., Ltd.

Start year/month: 2018-04-01 00:00:00+0900
End year/month:
Project/department name: Web application development

### Role: Engineer

Work content: I am working very hard on this!
https://metrust.jp/
Career 2

### Company: DeNA Co., Ltd.

Start year/month: 2012-07-01 00:00:00+0900
End year/month: 2013-09-01 00:00:00+0900
Project/department name: Sengoku Royal

### Role: Engineer

Work content: This is the team to which I was first allocated after the new graduate training.
We were working hard on development and operations in Perl using our in-house FW called MobaSiF.
Career 3

### Company: DeNA Co., Ltd.

Start year/month: 2013-10-01 00:00:00+0900
End year/month: 2014-06-01 00:00:00+0900
Project/department name: Gundam Royal

### Role: Engineer

Work content: Lead the development of numerous measures and new events.
I was able to win the internal MVP and the team won the president's award.
Career 4

### Company: DeNA Co., Ltd.

Start year/month: 2014-07-01 00:00:00+0900
End year/month: 2018-03-01 00:00:00+0900
Project/department name: Sakasho

### Role: Engineer

Work content: Engaged in development of mobile BaaS.
Reference: https://www.slideshare.net/blueskyblue/dena-sakasho
Participating community of other party

### Enjonia Association

Web start-up engineer
Re-learning of working people
Calling all board game lovers!
==========
Summarize the attractive point of Mr. Masahiro Yamada |METRUST-san into three points.
The output format should be as follows:
{number} 847f9dda-8afa-4ffa-b646-88f8a8df5956 {attractive point title} 847f9dda-8afa-4ffa-b646-88f8a8df5956 {attractive point content}{number} 847f9dda-8afa-4ffa-b646-88f8a8df5956 {attractive point title} 847f9dda-8afa-4ffa-b646-88f8a8df5956 {attractive point content}{number} 847f9dda-8afa-4ffa-b646-88f8a8df5956 {attractive point title} 847f9dda-8afa-4ffa-b646-88f8a8df5956 {attractive point content} . . .
Notes
{attractive point title} should be within 30 characters
{attractive point content} should be within 200 characters.
Add “san” to the company name. (Do not add “san” to YOUTRUST Co., Ltd.)

### Go”.

The generative AI 2 analyzes the affiliation, the job category, the self-introduction, the ability, the career, the participating community, and the like of the user information 111 in response to the request, and generates three attractive points. For example, “wide career experience”, “communication ability”, and “technical skill” are generated as attractive points.

After or in parallel with the above operation, the text generation means 104 performs display processing of the following screen on the display unit of the terminal 3b. The terminal 3b displays the following screen 30a on the display unit.

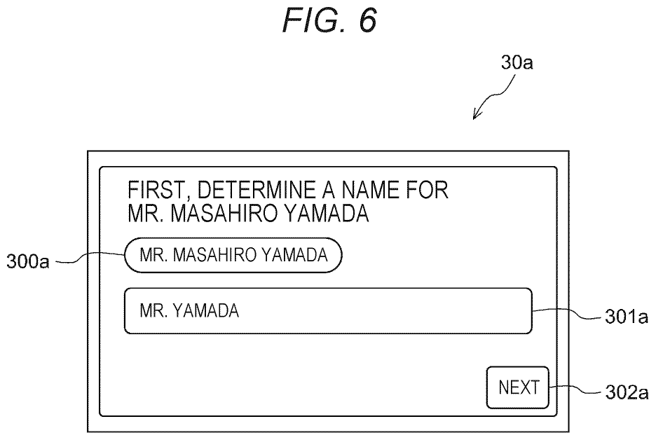

FIG. 6 is a schematic diagram illustrating a configuration example of a screen displayed on the display unit of each of the terminals 3a and 3b.

The screen 30a is a screen for determining a name for the transmission destination user of the scout sentence, and includes a user name 300a of the transmission destination, a name input field 301a, and a next button 302a for determining the name and transitioning to the next screen.

The user 5b checks the content of the screen 30a, inputs a desired name in the name input field 301a via the terminal 3b, and presses the next button 302a.

The text generation means 104 receives a name from the terminal 3b (S3).

Next, the text generation means 104 displays the following screen on the display unit of the terminal 3b in order to select a recruitment. The terminal 3b displays the following screen 30b on the display unit.

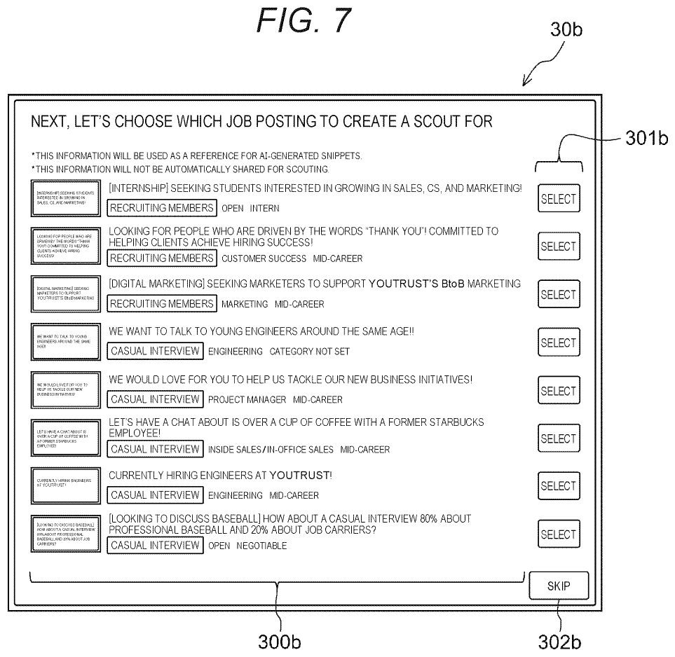

FIG. 7 is a schematic diagram illustrating a configuration example of a screen displayed on the display unit of each of the terminals 3a and 3b.

The screen 30b is a screen for selecting a recruitment for scouting, and includes a display field 300b in which a list of recruitment information created by the user 5b is displayed, a selection button 301b for selecting a recruitment, and a skip button 302b for transitioning to the next screen without selecting a recruitment.

The user 5b checks the content of the screen 30b, selects a desired recruitment via the terminal 3b, and presses the selection button 301b.

The recruitment selection means 101 selects, from the recruitment information 112, a job requisition for scouting on the basis of the content of an operation to the terminal 3b (S4). For example, a case where “Currently hiring engineers at YOUTRUST!” of recruitment ID “R003” in the recruitment information 112 in FIG. 4 is selected will be described.

Next, the text generation request means 103 understands the content of the selected recruitment of the recruitment information 112, and requests the generative AI 2 to generate a sentence for the user on the basis of the three attractive points extracted by the attractive point extraction request means 102 (S5).

The text generation request means 103 requests the generative AI 2 as follows, for example.

“Read and understand the recruitment information first.

### ========== Recruitment Information ==========

Title: Currently hiring engineers at YOUTRUST!
Text: YOUTRUST is hiring Web engineers for developing two products (career SNS/HR Tech Saas)!
If you are interested in development at YOUTRUST, let's start with a casual interview!
We will contact a person who seems to be compatible.

### Essential Skills

At least three years of practical development experience using the MVC framework in LL languages such as Ruby, PHP, and Python—DB design/operation experience considering normalization and index in MySQL (registered trademark)—operation experience of public cloud services using AWS, GCP, and the like
Team development experience with multiple persons using GitHub

### Preferred Skills

Front-end development experience
Experience in development and operation of web API (REST, GraphQL, gRPC) for native applications and frontend—Experience in development using Ruby on Rails
Experience in building development processes such as CI and automated tests
Experience in product management
Development experience in large services
Experience with large-scale refactoring
Deep knowledge on QA
Deep knowledge on security
   You are Haruto Sato, a recruiter for a company “YOUTRUST CO., LTD.”. You are about to transmit a scout message to Mr. Masahiro Yamada.
Scout text
   One of the attractive points of Mr. Masahiro Yamada is his “communication ability”.
   Mr. Yamada, who is also a member of “Enjonia Association”, also values interaction between engineers. He learns new knowledges and utilizes them in his work. Create text addressing this point.
Notes
   Note the following points when creating the scout text.
The amount of text should be within about 100 to 150 characters.
Do not make the writing too stiff.
Do not sound overbearing.
Try to avoid using a definitive tone. Use phrases like “I thought . . . ”. Use polite language. (Phrases like “I thought”, “I felt”, “deshita”, “mashita” (polite language)). Add “san” to the company name. (Do not add “san” to YOUTRUST Co., Ltd.)
Words to avoid
You
Output format of scout text
   A typical scout configuration is as follows.
1. {{Introduction greeting}}
2. {{Description of company}}
3. {{personalized text}}
4. {{Scheduling appointment for interview}}
5. {{Closing remarks}}
   Output only the third {{personalized text}} part of the above.
Configuration of {{personalized text}} of scout text Also mention the image of personnel you are looking for in your company from the recruitment information.
   As a preferable configuration, first, challenges our company is facing and an image of personnel that we are looking for may be mentioned.
   Next, it may be good to explain that we are seeking a person with a background similar to that of Mr. Masahiro Yamada.
   Then, on the basis of the profile of the other party, output only the portion of {{personalized text}} in about 100 to 150 characters”.

The text generation request means 103 requests to generate a sentence for each attractive point, but may request to generate a sentence for a plurality of attractive points.

The generative AI 2 generates a sentence for the user of the scout target according to the content of the recruitment in response to the request. Specifically, three sentences are generated according to each of the three attractive points.

The text generation means 104 receives the generation result generated by the generative AI 2 (S6), and performs display processing of the following screen on the terminals 3a, 3b, . . .

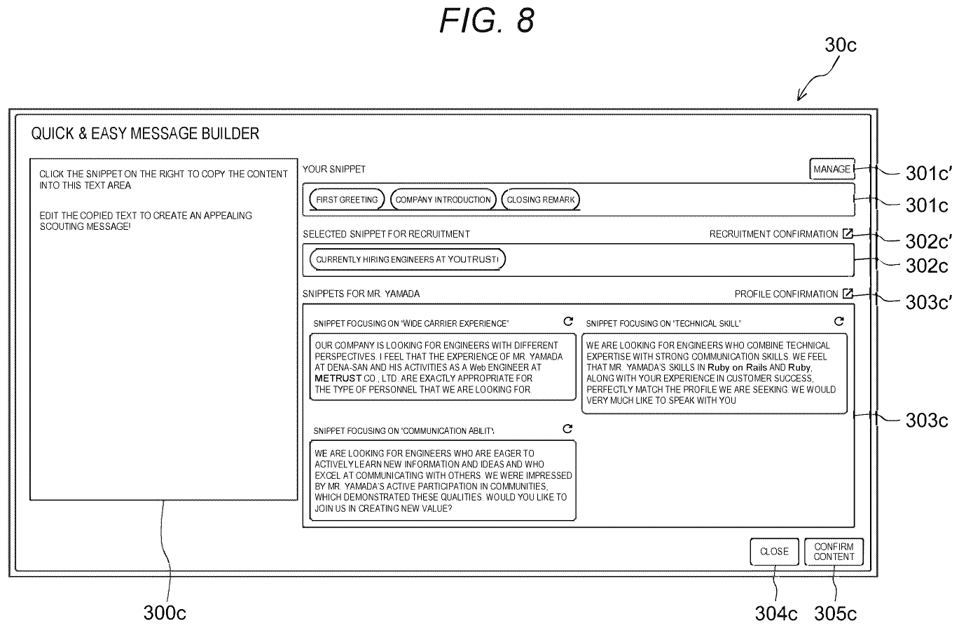

FIG. 8 is a schematic diagram illustrating a configuration example of a screen displayed on the display unit of each of the terminals 3a and 3b.

A screen 30c is a screen for creating a scout sentence, and includes an area 300c for copying and inputting text, an area 301c in which a fixed phrase is displayed, an area 302c in which the content of the selected recruitment is displayed, an area 303c in which the sentence of the generation result generated by the generative AI 2 is displayed, a close button 304c for canceling the creation of the scout sentence, and a content confirmation button 305c for confirming the content copied and input in the area 300c. The screen 30c also includes a management button 301c′ for managing fixed phrases, a recruitment confirmation button 302c′ for confirming the content of the selected recruitment in a separate window, and a profile confirmation button 303c′ for confirming the profile of the transmission destination user in a separate window.

The user 5b confirms the content of the screen 30c, selects a desired sentence candidate (hereinafter sometimes referred to as “snippet”) from the snippets displayed in the areas 301c, 302c, and 303c via the terminal 3b, and copies and inputs the selected snippet into the area 300c.

Note that the scout sentence to be created is as follows, for example, in a case where a first greeting, a company introduction, a snippet focusing on “wide career experience” among snippets directed to Mr. Yamada, and a closing remark are selected.

“Mr. Yamada
Nice to meet you. My name is Sato from YOUTRUST Co., Ltd.
We are passionate about developing sustainable energy solutions. We welcome those who will drive innovative projects using their knowledge and skills in thermodynamics for the development of next-generation energy technologies. Our company is looking for engineers with different perspectives. I feel that the experience of Mr. Yamada at DeNA-san and his activities as a web engineer at METRUST Co., Ltd. are exactly appropriate for the type of personnel that we are looking for.
Would you be available for a casual interview?

### That is all.

I apologize for bothering you during such a busy time, but I look forward to your reply”.

The user 5b confirms the content input in the area 300c, and presses the content confirmation button 305c if the content is satisfactory.

Next, the text generation means 104 receives the operation content (S7), generates the scout sentence information 114 on the basis of the operation content, stores the scout sentence information 114 in the storage unit 11 (S8), and displays a screen (not illustrated) for confirming whether to transmit the generated scout sentence information 114 to the user 5a.

The user 5b confirms the content of the screen and operates the terminal 3b to request transmission. The terminal 3b transmits a transmission request to the information processing apparatus 1 according to the operation content.

The text generation means 104 of the information processing apparatus 1 transmits and outputs the scout sentence to the user 5a in response to the transmission request (S9). Note that the output is not limited to the transmission of the scout sentence, and text data may be generated. In this case, the text data is edited by the user 5b, for example, and then manually transmitted.
(3) Fixed phrase registration and editing operation

When the user 5b operates the terminal 3b to manage a fixed phrase to be used for a scout sentence to be transmitted when scouting personnel (for example, presses management button 301c′ in FIG. 8), a request is transmitted from the terminal 3b to the information processing apparatus 1, and the following screen is displayed on the display screen of the terminal 3b as a response.

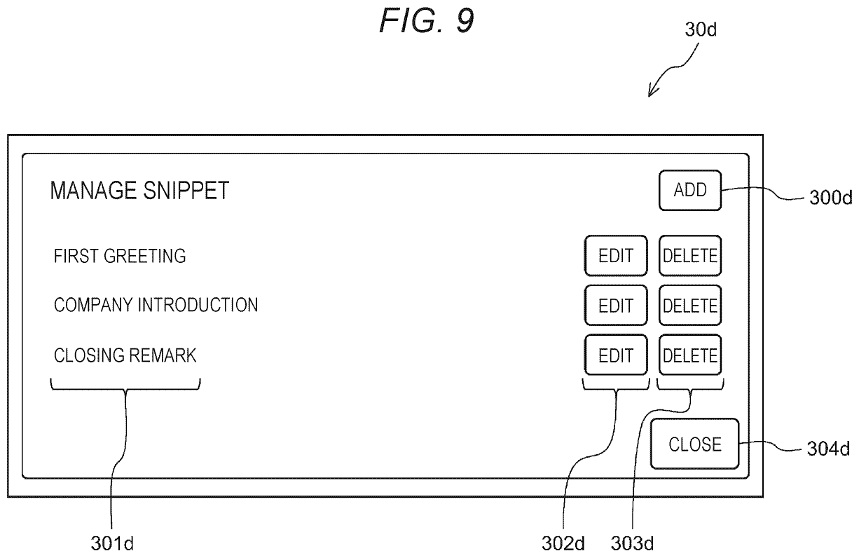

FIG. 9 is a schematic diagram illustrating a configuration example of a screen displayed on the display unit of each of the terminals 3a and 3b.

A screen 30d is a screen that is displayed when the fixed phrase information 113 is managed, and includes an addition button 300d for adding a new fixed phrase, a fixed phrase title 301d of the fixed phrase registered as the fixed phrase information 113, an edit button 302d for editing the fixed phrase, a delete button 303d for deleting the fixed phrase, and a close button 304d for ending the management of the fixed phrase information 113.

While confirming the content of the screen 30d, the user 5b presses the edit button 302d for a desired fixed phrase in order to edit the content of the fixed phrase, and presses the addition button 300d in order to add a new fixed phrase.

The terminal 3b transmits a request to the information processing apparatus 1 according to the operation content, and as a response, the following screen is displayed on the display screen of the terminal 3b.

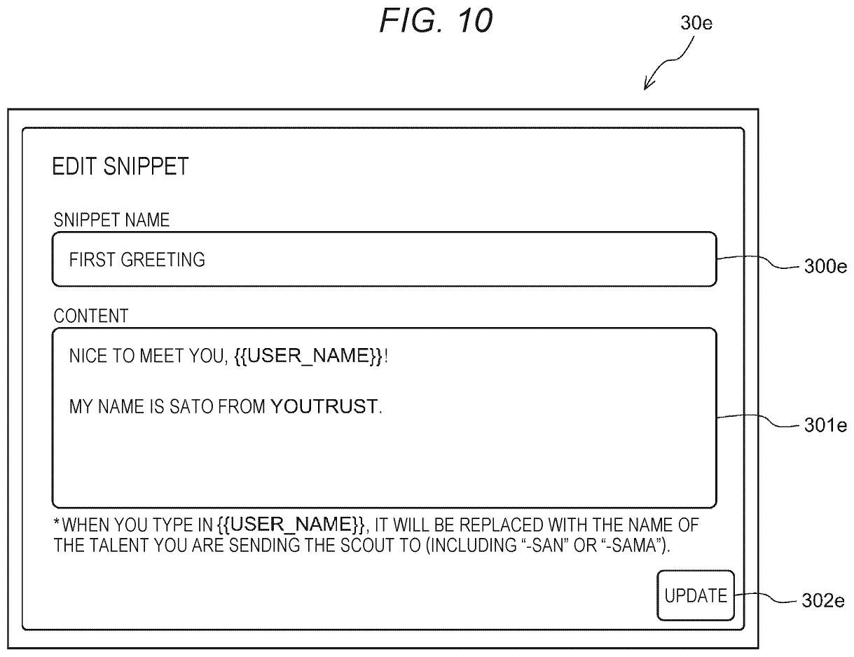

FIG. 10 is a schematic diagram illustrating a configuration example of a screen displayed on the display unit of each of the terminals 3a and 3b.

A screen 30e is a screen displayed when the fixed phrase information 113 is edited (added). The screen 30e is displayed by pressing the edit button 302d (addition button 300d) on the screen 30d, and includes a fixed phrase title input field 300e, a fixed phrase content input field 301e, and an update button 302e.

While confirming the content of the screen 30e, the user 5b inputs text and the like into the fixed phrase title input field 300e and the fixed phrase content input field 301e to edit (add) the content of the fixed phrase, and presses the update button 302e when the editing (addition) is completed.

The terminal 3b transmits a request to the information processing apparatus 1 according to the operation content, and the text generation means 104 of the information processing apparatus 1 records the input information as the fixed phrase information 113 in response to the request.

### Effects of Embodiment

According to the above-described embodiment, the generative AI is requested to extract an attractive point of a user from the user information 111, the generative AI is requested to generate, from the recruitment information 112, a scout sentence for the user on the basis of the attractive point extracted according to the content of a recruitment, and the scout sentence is generated using the generated sentence. Therefore, it is possible to create a sentence according to the transmission destination user and the transmission purpose in addition to combining the fixed phrases prepared in advance.

### Other Embodiments

Note that the present invention is not limited to the above embodiment, and various modifications can be made without departing from the gist of the present invention.

For example, after the attractive point of the user is extracted from the profile of the user in step S2, the content of the recruitment is requested to be understood in step S5. However, the selection of the user to be the scout target and the selection of the recruitment may be performed first, and the operation of extracting the attractive point of the user from the profile of the user and the operation of understanding the content of the recruitment may be requested while performing other processing. Normally, in the generative AI 2, the attractive point extracting operation and the understanding operation of the recruitment content require time. Therefore, by advancing these operations in parallel with the reception of operation from the user and other processing, the waiting time of the user can be reduced.

In addition, the text generation request means 103 may request the generative AI 2 to learn past text of the transmission source user and adapt the generated sentence to a style resembling the transmission source user.

Furthermore, when requesting the generation of the sentence, the text generation request means 103 may request the generative AI 2 to mention a common career of a user who is a common friend on the SNS between the transmission source user and the transmission destination user. As a result, since the scout sentence includes the topic of the user who is a common friend, it is possible to give a sense of security and credibility with respect to the transmission source user to the transmission destination user who is the reader, and an improvement in the response rate can be expected.

Furthermore, the text generation request means 103 may request the generative AI 2 to learn sentence generation using a scout sentence with a high response rate. As a result, a scout sentence with a high response rate can be generated.

In the above embodiment, the functions of the means 100 to 104 of the control unit 10 are implemented by the program, but all or some of the means may be implemented by hardware such as ASIC. In addition, the program used in the above embodiment can be provided by being stored in a recording medium such as a CD-ROM. Replacement, deletion, addition, and the like of the above steps described in the above embodiment can be performed within the scope of not changing the gist of the present invention.

### Industrial Applicability

A text generation program and an information processing apparatus for creating a sentence according to transmission destination user and a transmission purpose are provided.

1. A non-transitory computer-readable medium storing instructions that, when executed by one or more processors, cause a computer to:
receive a selection of a transmission destination user and pre-stored recruitment information;
generate, using a generative AI, a plurality of candidate attributes by extracting the plurality of candidate attributes from user information associated with the transmission destination user; and
generate, using the generative AI, a message for the transmission destination user based on the pre-stored recruitment information and the plurality of candidate attributes.

2. The non-transitory computer-readable medium according to claim 1, further causing the computer to generate a message using at least one of (i) a sentence generated by the generative AI and (ii) a pre-stored fixed phrase.

3. The non-transitory computer-readable medium according to claim 2, wherein the computer is further caused to generate the message in a type different from a type of the pre-stored fixed phrase.

4. The non-transitory computer-readable medium according to claim 1, wherein the computer is further caused to train the generative AI using past messages of a transmission source user such that the generated message reflects a style of the transmission source user.

5. The non-transitory computer-readable medium according to claim 1, wherein the computer is further caused to generate the message to include information relating to a shared connection between the transmission source user and the transmission destination user..

6. The non-transitory computer-readable medium according to claim 1, wherein the computer is further caused to train the generative AI using messages associated with a high response rate.

7. An information processing apparatus comprising:
one or more processors; and
a memory storing instructions that, when executed by the one or more processors, cause the apparatus to:
receive a selection of a transmission destination user and pre-stored recruitment information;
generate, using a generative AI, a plurality of candidate attributes from user information associated with the transmission destination user; and
generate, using the generative AI, a message for the transmission destination user based on the pre-stored recruitment information and the plurality of candidate attributes.

8. A sentence generation method comprising:
a step of receiving selection of a transmission destination user and pre-stored recruitment information;
a step of generating, using a generative AI, a plurality of candidate attributes by extracting the plurality of candidate attributes from user information associated with the transmission destination user; and
a step of generating, using the generative AI, a message for the transmission destination user based on the pre-stored recruitment information and the plurality of candidate attributes.

9. An information processing system comprising:
a generative AI configured to generate at least a sentence; and
an information processing apparatus comprising:
one or more processors; and
a memory storing instructions that, when executed by the one or more processors, cause the apparatus to:
receive a selection of a transmission destination user and pre-stored recruitment information;
generate a plurality of candidate attributes by extracting the plurality of candidate attributes from user information associated with the transmission destination user; and
generate the message using the generative AI based on the pre-stored recruitment information and the plurality of candidate attributes.

10. The non-transitory computer-readable medium according to claim 1, wherein the message is a scout message for recruiting the transmission destination user.

11. The non-transitory computer-readable medium according to claim 1, wherein the message includes at least one sentence generated by the generative AI.

12. The non-transitory computer-readable medium according to claim 1, wherein the pre-stored recruitment information includes information relating to a job position or a recruiting entity.

13. The non-transitory computer-readable medium according to claim 1, wherein the plurality of candidate attributes correspond to attractive points of the transmission destination user extracted from the user information.

14. The non-transitory computer-readable medium according to claim 1, wherein the computer is further caused to generate the message to include information relating to a common career associated with a shared connection between the transmission source user and the transmission destination user.

15. The non-transitory computer-readable medium according to claim 1, wherein the computer is further caused to train the generative AI using scout messages associated with a high response rate.

16. The non-transitory computer-readable medium according to claim 2, wherein the pre-stored fixed phrase includes a template for a scout message.
